(19) United States
(12) Patent Application Publication
(10) Pub. No.: US 2006/0088809 A1
(43) Pub. Date: Apr. 27, 2006

(54) Shoe lace teacher for pre-schoolers

(76) Inventors: June Mae Blake, Chesapeake Beach, MD (US); Victor Jones Blake, Chesapeake Beach, MD (US)

Correspondence Address: JUNE MAE BLAKE, 3510 DORY BROOKS ROAD, CHESAPEAKE BEACH, MD, 20732, US

(21) Appl. No.: 10/969,610

(22) Filed: Oct. 21, 2004

(51) Int. Cl. G09B 19/24

(52) U.S. Cl. 434/260

(57) ABSTRACT

The shoelace teacher is a round device that is implanted into the tongue of the shoe that will give a child step by step instructions on how to tie the shoe lace. This disk is pre recorded and is repeatable with these instructions, but not limited to this example: “First you make a tie, then you make one bunny ear, then you rap your lace around and push it through, and then pull”. This can be permanently fixed in one style or have a style where the disk can be removed by an adult when instruction is no longer needed. The idea is to have ready instructions for the tying of the shoe lace at all times.

### BACKGROUND OF INVENTION

In April 2004 the got this idea. The reason why is because of my five grandchildren. I want to think of a way that their busy moms could get help with teaching them how to tie their shoes. I immediately ordered a customer number from United States Patent and Trademark office. I felt that this was a unique idea and it would save time for busy parents. Also, Stimulate hand and eye coordination. I saw how it would help with listening skills and promote autonomy in young children.

In June I tried to fine a company to help me and was disappointed. So I call the USPTO and got all of the help that I needed to submit my paper work for patient security. I conducted the online search and didn't fine anything identical to this.

### BRIEF SUMMARY OF THE INVENTION

The idea of the shoe lace teacher is a teaching device. The invention will teach Children how to lace their shoes and save small children from injury.

### BRIEF DESCRIPTION OF THE DRAWINGS

A small circular disk is placed inside of the tongue of a sneaker. When it is pressed is will activate step by step and explain how to tie the shoe lace.

### Description

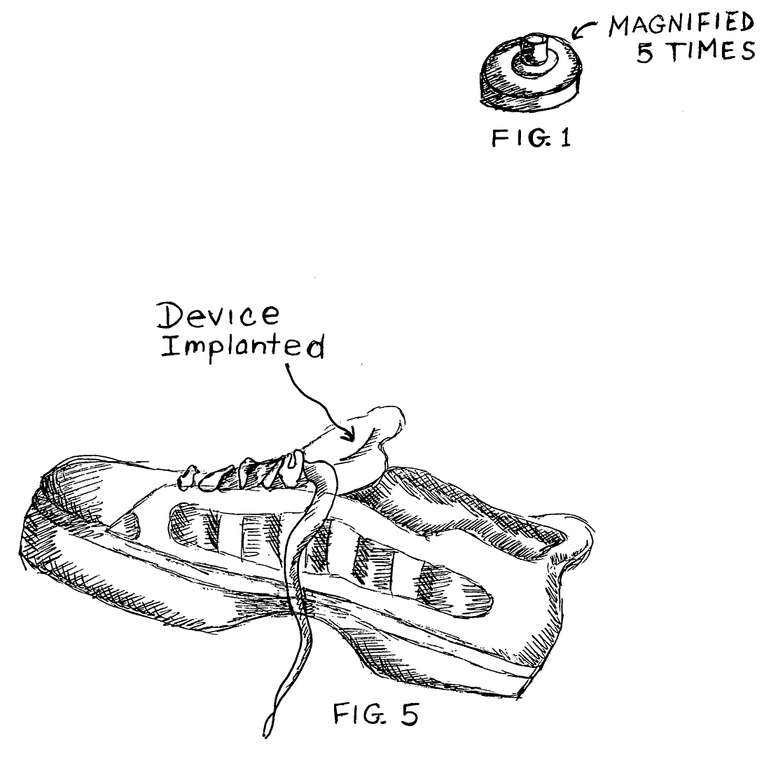

FIG. 1 is a perspective view of the shoe lace element magnified five times showing my new design;

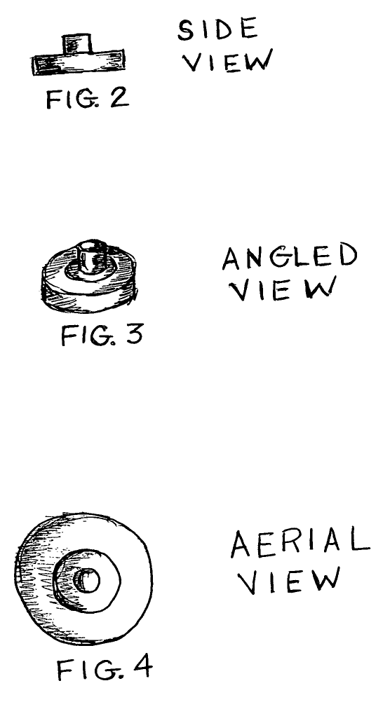

FIG. 2 is a side view thereof;

FIG. 3 is an angled view thereof;

FIG. 4 is an aerial view thereof;

1. What I claim as my invention is, the idea to implant a device into the shoe that will rehearse step by step instructions on how to tie a shoe lace:

2. What I claim as my invention is, a round instrument inserted into the upper part of the tongue of a shoe that will be activated when pressed with shoe string tie methods.
